(19) United States
(12) Patent Application Publication
(10) Pub. No.: US 2015/0154294 A1
(43) Pub. Date: Jun. 4, 2015

(54) SUGGESTED DOMAIN NAMES POSITIONING BASED ON TERM FREQUENCY OR TERM CO-OCCURRENCE

(71) Applicant: Go Daddy Operating Company, LLC, Scottsdale, AZ (US)

(72) Inventors: Tapan Kamdar, San Jose, CA (US); Wei-Cheng Lai, Cupertino, CA (US)

(73) Assignee: Go Daddy Operating Company, LLC, Scottsdale, AZ (US)

(21) Appl. No.: 14/289,583

(22) Filed: May 28, 2014

Related U.S. Application Data
(63) Continuation-in-part of application No. 14/173,346, filed on Feb. 5, 2014.
Application No. 14/173,346 is a continuation-in-part of application No. 14/097,022, filed on Dec. 4, 2013.

(51) Int. Cl. G06F 17/30

(52) U.S. Cl. CPC G06F 17/30864

(57) ABSTRACT

A dictionary, containing a first plurality of terms, phrases, tokens and/or words (hereafter terms) may be built and stored on a server computer. The dictionary may also store how frequently the terms appear and/or how frequently the terms appear together (co-occurrence) in a body of text. A second plurality of terms may be generated that are associated with a user. A plurality of domain names may be created by combining one or more terms in the second plurality of terms along with a domain name extension, Created domain names comprising frequently used terms and/or co-occurring terms, based on data from the dictionary, may be displayed on a website more prominently, before or instead of domain names for the user to select for registration than domain names that comprise less frequently used and/or less frequently co-occurring terms.

### CROSS REFERENCE TO RELATED APPLICATIONS

This continuation-in-part application is based upon and claims benefit of priority from the prior U.S. patent application Ser. No. 14/173,346, filed on Feb. 5, 2014, which is a continuation-in-part application based upon and claims the benefit of priority from the prior U.S. patent application Ser. No. 14/097,022, filed on Dec. 4, 2013, the entire contents of which are incorporated herein by reference,

### FIELD OF THE INVENTION

The present invention generally relates to the field of positioning suggested domain names on a website to a user and, as a specific example, to the field of positioning suggested domain names on the website to the user based on the frequency and/or co-occurrence of terms within the domain names.

### SUMMARY OF THE INVENTION

The present invention provides methods for spinning name identifiers, such as domain names, using interactive tokens and keywords. An exemplary method may start with a name identifier registering entity, such as, as non-limiting examples, a social media platform, a domain name reseller, Registrar, or Registry, receiving a user search from a user. The user search may be entered in a data entry field on a webpage of a website, generated using information associated with the user found on the Internet or in one or more proprietary databases, or generated from a keyword spinner. The user search may be a domain name or a plurality of words (with our without spaces) and may be parsed into one or more words.

Adjacent or neighboring words may be analyzed to determine if there are any entities, such as, as a non-limiting example, n-grams, in the one or more words. Entities or words that have not been found to be helpful in the past may also be dropped from consideration. In addition, words that are prepositions, pronouns, articles, or that have been found in past to be unhelpful, may be dropped from consideration. The remaining entities and words may be tokenized, i.e. each entity and/or remaining word may be assigned to represent a token. While any number of tokens may be found and used, it is preferable, simply for display and practical reasons (for example, longer domain names or social media handles are generally less desirable than shorter ones), to limit the number of tokens to two, three, four, or five.

Zero or more keywords may be found for each token. The keywords may be synonyms, words related or often associated with one of the tokens, commonly purchased together, and/or experimental words. Each token and its plurality of keywords may be displayed, preferably in a vertical list, on a webpage to the user. Thus, for example, if three tokens are selected, there would be three lists. There are preferably check boxes, data entry fields, menus, tag clouds, or other ways on the webpage to allow the user to select zero or more keywords from each list.

The user may be given the capability to add, delete, edit, reorder, and/or lock tokens. The webpage preferably automatically updates to reflect the user's manipulation of the tokens, e.g. newly added tokens are shown (with corresponding keywords), while deleted tokens (and their keywords) are no longer shown on the webpage.

The user may select zero or more keywords at any time during the process. When the user has finished manipulating the tokens and selected the desired keywords, the user may indicate that the user is ready to spin, i.e. create a new batch of name identifiers, such as domain names or social media handles (names).

Domain names may be created by combining various tokens from a set of keywords and a domain name extension. In a preferred embodiment, only zero or one token or selected keyword from each list is combined with a single domain name extension. Limiting only zero or one token or selected keyword from each list reduces the chance of having synonyms in the same suggested domain name which might unnecessarily and undesirably increase the length of a suggested domain name.

The name identifiers, such as domain names, are preferably prioritized, or a methodology used, so that the name identifiers that are mostly likely to be chosen have a higher priority than name identifiers that are less likely to be chosen. If the number of name identifiers exceeds a predetermined number, the lower priority name identifiers may be dropped from consideration.

The remaining created name identifiers may be checked for availability. Name identifiers that are available may be displayed on a webpage designed for this purpose, preferably with the highest priority name identifiers in the most prominent positions.

The user may select zero or more name identifiers for registration, in which case the selected name identifiers may be registered to the user. As a specific, non-limiting example, selected domain names may be registered with a Registry. Alternatively, or in addition, the user may enter a new user search or add, delete, edit, reorder, and/or lock one or more tokens to cause a new batch of name identifiers to be displayed on a webpage that may be selected for registration.

In another embodiment, a method is disclosed for suggesting a domain name on a website for a user based on the relatedness of one or more tokens (or even keywords) with a domain name's corresponding domain name extension, based on the relatedness of the user with the domain name's corresponding domain name extension, or some combination thereof. In this embodiment, a plurality of tokens may be generated that are associated with a user. A plurality of domain name extensions may be analyzed to determine the domain name extension that is most related to the plurality of tokens, to the user, or to some combination thereof. A domain name may be created by combining one or more tokens in the plurality of tokens with the domain name extension that is most related to the plurality of tokens, to the user, or to some combination thereof. The domain name may then be displayed on the website for the user to select for registration at the user's discretion.

This embodiment may also allow the user to manipulate the tokens on the website. In addition, the availability of the domain name may be checked and only displayed on the website to the user if the domain name is available for registration.

In another embodiment, a method is disclosed for positioning suggested domain names on a website for a user based on the relatedness of one or more tokens with the domain names' corresponding domain name extensions, based on the relatedness of the user with the domain names' corresponding domain name extensions, or some combination thereof. In this embodiment, a plurality of tokens associated with a user may be generated. A plurality of domain name extensions may be ranked based on a relatedness of each domain name extension with the plurality of tokens, with the user, or some combination thereof. A plurality of domain names may be created by repeatedly combining one or more tokens in the plurality of tokens with a domain name extension in the plurality of domain name extensions. Preferably, only top ranked domain name extensions are used to create the plurality of domain names. The domain names that have higher ranked domain name extensions may be presented to the user on the website before domain names that have lower ranked domain name extensions. The user may then select on the website one or more of the presented domain names for registration.

This embodiment may also allow the user to manipulate the tokens on the website. In addition, the availability of the created domain names may be checked prior to being displayed, and only the available domain names are displayed on the website to the user.

In another embodiment, a method is disclosed for positioning suggested domain names on a website for a user based on a payment received from the seller (which could be, as non-limiting examples, an individual or a Registry) and/or a relatedness of one or more tokens with the domain names' corresponding domain name extensions, based on the relatedness of the user with the domain names' corresponding domain name extensions, or some combination thereof. In this embodiment, a plurality of tokens associated with a user may be generated. A plurality of domain name extensions may be ranked based on the payment received from the seller and/or the relatedness of each domain name extension with the plurality of tokens, the relatedness of each domain name extension with the user, or some combination thereof. A plurality of domain names may be created by repeatedly combining one or more tokens in the plurality of tokens with a domain name extension in the plurality of domain name extensions. Preferably, only top ranked domain name extensions are used to create the plurality of domain names. The domain names that have higher ranked domain name extensions may be presented to the user on the website before domain names that have lower ranked domain name extensions. The user may then select on the website one or more of the presented domain names for registration.

This embodiment may also allow the user to manipulate the tokens on the website. In addition, the availability of the created domain names may be checked prior to being displayed, and preferably only the available domain names are displayed on the website to the user.

In another embodiment, a dictionary, containing a first plurality of terms, tokens and/or words (hereafter terms) may be built and stored on a server computer. The dictionary may also store how frequently the terms appear and/or how frequently the terms appear together (co-occurrence) in a body of text. A second plurality of terms may be generated that are associated with a user. A plurality of domain names may be created by combining one or more terms in the second plurality of terms along with a domain name extension. Created domain names comprising frequently used terms and/or co-occurring terms, according to the dictionary, may be displayed more prominently, before or instead of domain names that comprise less frequently used and/or less co-occurring terms on a website for the user to select for registration, at the user's discretion.

The above features and advantages of the present invention will be better understood from the following detailed description taken in conjunction with the accompanying drawings.

### BRIEF DESCRIPTION OF THE DRAWINGS

FIG. 1 is a block diagram of a system that may be used to practice the present invention.

FIG. 2 illustrates a portion of a webpage of a website for allowing a user to enter a user search into a data entry field.

FIG. 3 illustrates possible tokens that may be created from an example user search.

FIG. 4 illustrates a portion of a webpage displaying a plurality of lists, wherein each list comprises a token and keywords related to the token.

FIG. 5 illustrates a portion of a webpage displaying a plurality of lists, wherein each list comprises a token and keywords related to the token.

FIG. 6 illustrates a portion of a webpage displaying a plurality of lists, wherein each list comprises a token and keywords related to the token.

FIG. 7 illustrates a portion of a webpage displaying a plurality of lists, wherein each list comprises a token and keywords related to the token,

FIG. 8 illustrates a portion of a webpage displaying a plurality of lists, wherein each list comprises a token and keywords related to the token.

FIG. 9 illustrates a portion of a webpage displaying a plurality of available domain names created based on the tokens and selected keywords.

FIG. 10 is a first part of a flow diagram illustrating an example embodiment of a method for domain name spinning using interactive keywords.

FIG. 11 is a second part of a flow diagram illustrating an example embodiment of a method for domain name spinning using interactive keywords.

FIG. 12 is a table illustrating a relatedness of a plurality of tokens to a plurality of domain name extensions.

FIG. 13 is a flow diagram illustrating an example embodiment of a method for practicing the invention.

FIG. 14 is a flow diagram illustrating an example embodiment of a method for practicing the invention.

FIG. 15 is a flow diagram ustrating an example embodiment of a method for practicing the invention.

FIG. 16 is a flow diagram illustrating an example embodiment of a method for practicing the invention using term frequency and/or term co-occurrence.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures_{;} and method steps have not been described in particular detail in order to avoid unnecessarily obscuring the present invention. Unless otherwise indicated, like parts and method steps are referred to with like reference numerals.

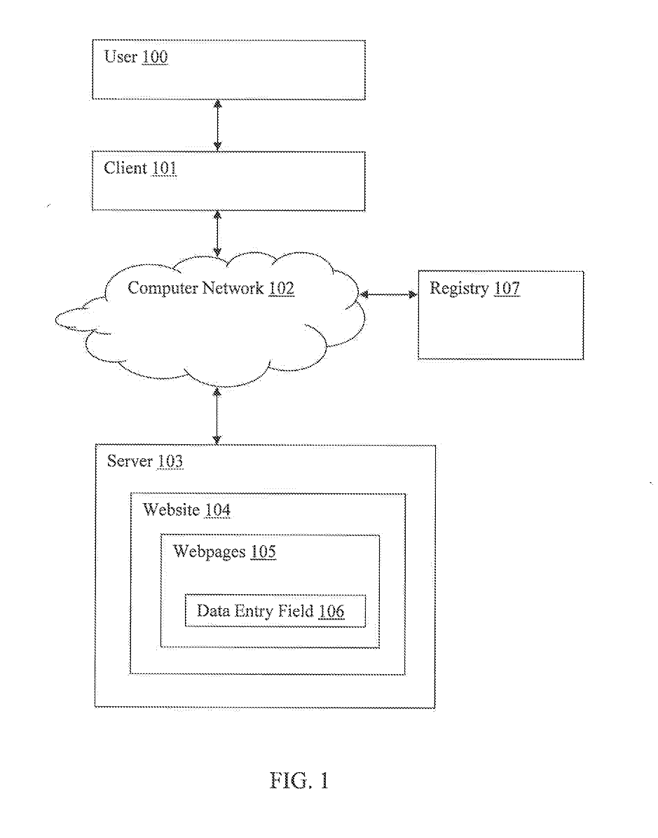

FIG. 1 is a block diagram of a system that may be used to practice the present invention. A computer network 102 is a collection of links and nodes (e.g., multiple computers and/or other devices connected together) arranged so that information may be passed from one part of the computer network 102 to another over multiple links and through various nodes. Examples of computer networks 102 include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users 100 on clients 101. Hundreds of millions of people around the world have access to computers (clients 101) connected to the Internet via Internet Service Providers (ISPs). Content providers place multimedia information (e.g., text, graphics, audio, video, animation, and other forms of data) at specific locations on the Internet referred to as websites 104. The combination of all the websites and their corresponding web pages on the Internet is generally known as the World Wide Web (WWW) or simply the Web.

For Internet users 100 and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other.

Prevalent on the Web are multimedia websites 104, some of which may offer and sell goods and services to individuals and organizations. Websites 104 may consist of a single webpage 105, but typically consist of multiple interconnected and related webpages 105. Websites 104, unless very large and complex or have unusual traffic demands, typically reside on a single server 103 and are prepared and maintained by a single individual or entity (although websites 104 residing on multiple servers 103 are certainly possible). Menus, links, tabs, etc. may be used to move between different web pages 105 within the website 104 or to move to a different website.

Websites 104 may be created using HyperText Markup Language (HTML) to generate a standard set of tags that define how the webpages 105 for the website 104 are to be displayed. Users 100 of the Internet may access content providers' websites 104 using software known as an Internet browser, such as MICROSOFT INTERNET EXPLORER or MOZILLA FIREFOX. After the browser has located the desired webpage 105, it requests and receives information from the webpage, typically in the form of an HTML document, and then displays the webpage content for the user 100 on the client 101. The user 100 then may view other webpages 105 at the same website 104 or move to an entirely different website using the browser.

Some Internet users 100, typically those that are larger and more sophisticated, may provide their own hardware, software, and connections to the Internet. But many Internet users 100 either do not have the resources available or do not want to create and maintain the infrastructure necessary to host their own websites. To assist such individuals (or entities), hosting companies exist that offer website hosting services. These hosting providers typically provide the hardware, software, and electronic communication means necessary to connect multiple websites to the Internet. A single hosting provider may literally host thousands of websites on one or more hosting servers 103.

Browsers are able to locate specific websites 104 because each website 104, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website 104 on the Internet through the use of a URL. The URL may include a Hypertext Transfer Protocol (HTTP) request combined with the website's 104 Internet address, also known as the website's 104 domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the Registry 107 is also the authoritative source for contact information related to the domain name and is referred to as a “thick” Registry 107. For other TLDs (e.g., .com and .net) only the domain name, registrar identification, and name server information is stored within the Registry 107, and a Registrar is the authoritative source for the contact information related to the domain name, Such Registries 107 are referred to as “thin” registries 107. Most gTLDs are organized through a central domain name Shared Registration System (SRS) based on their TLD. TLDs may also be referred to as domain name extensions.

The process for registering a domain name with .com, .net, .org, and some other TLDs allows an Internet user 100 to use an ICANN-accredited Registrar to register their domain name. For example, if an Internet user 100, John Doe, wishes to register the domain name “mycompany.com,” John Doe may initially determine whether the desired domain name is available by contacting a domain name registrar. The Internet user 100 may make this contact using the Registrar's webpage and typing the desired domain name into a field on the registrar's webpage created for this purpose. Upon receiving the request from the Internet user 100, the Registrar may ascertain whether “mycompany.com” has already been registered by checking the SRS database associated with the TLD of the domain name or by checking with the Registry. The results of the search then may be displayed on the webpage to thereby notify the Internet user 100 of the availability of the domain name. If the domain name is available, the Internet user 100 may proceed with the registration process. If the domain name is not available for registration, the Internet user 100 may keep selecting alternative domain names until an available domain name is found,

A current problem many Internet users 100 face is trying to find a domain name that is available. A similar problem exists in trying to find a handle or name with a social media platform. It is generally desirable to have a domain name (or social media handle) that is as generic and short as possible. A generic domain name makes a website 104 easier to find, thereby increasing its traffic, while shorter domain names are easier to remember and enter into a browser. Unfortunately, many people want the same short generic domain names making it difficult for new Internet users 100 to find a good domain name that is not already registered. The present invention addresses the problem of finding a good available domain name or social media handle.

A user 100 will typically be a person trying to register one or more domain names or a social media handle. The user 100 may use a client 101, such as, as non-limiting examples, a cell phone, PDA, tablet, laptop computer, or desktop computer to access a website 104 via a computer network 102, such as the Internet.

The website 104 may have a plurality of webpages 105. The website 104 may be hosted or operated from a server 103. The server 103 may be, as a non-limiting example, one or more Dell PowerEdge(s) rack server(s), HP Blade Servers, IBM Rack or Tower servers, although other types of servers, combinations of one or more servers, server software and applications may be used. The webpages 105 may have one or more display fields as well as one or more data entry fields 106. The data entry fields 106 allow the user 100 to enter data into the website 104 from a client 101.

One or more Registries 107 may be connected to the computer network 102, which is preferably the Internet, so that the Registries' 107 functions may be easily accessed by electronic commands. While any number of different functions from the Registry 107 may be used, the present invention is primarily concerned with using the Registry 107 to determine if one or more domain names are available for registration and registering one or more domain names to the user 100. A similar process may be used for social media platforms instead of domain name Registries 107.

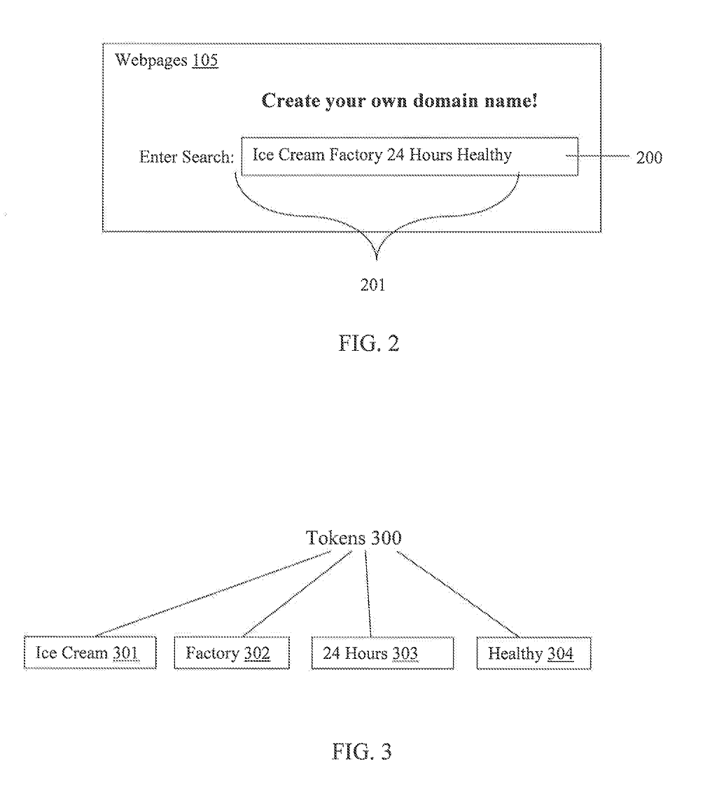

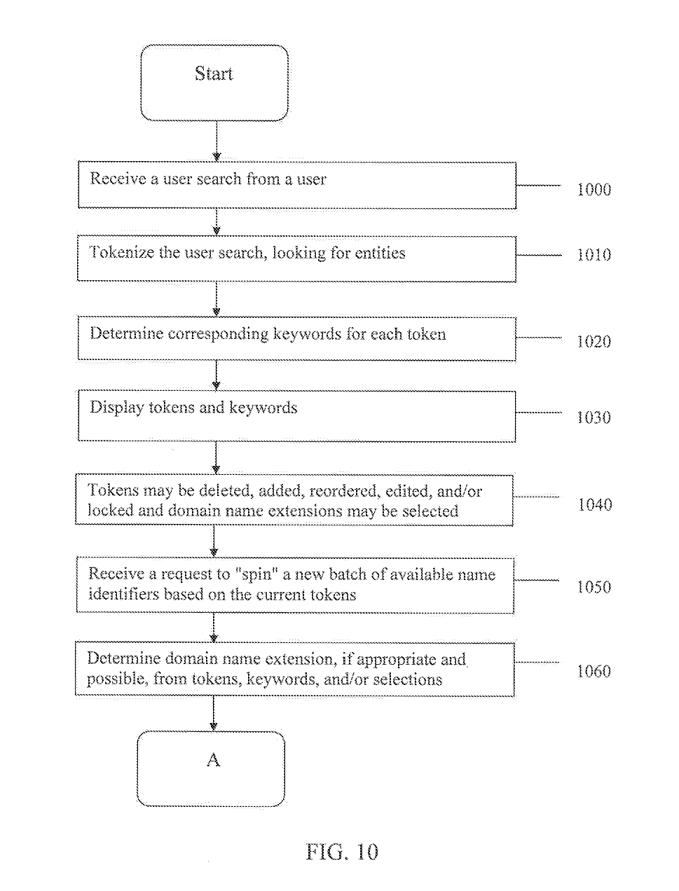

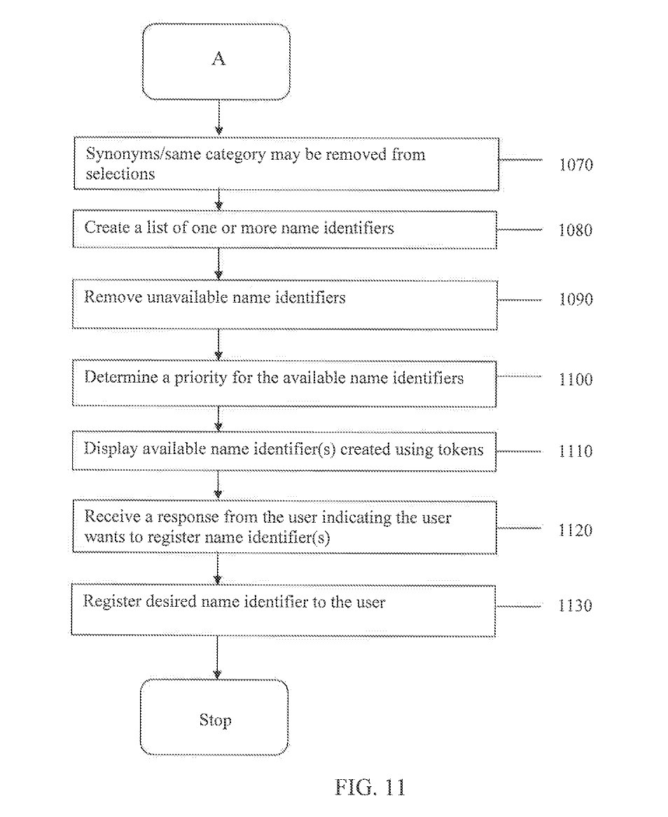

An exemplary process for practicing the invention is illustrated in FIGS. 10 and 11. A user 100 may enter a user search 201 into a data entry field 200 on a webpage 105 of a website 104 as illustrated in FIG. 2. (Step 1000) In FIG. 2, the user 100 has entered a user search 201 of “Ice Cream Factory 24 Hours Healthy” from the user's client 101. The user 100 may enter any number of different character strings that may be received and analyzed as a user search 201, by a server 103, with the current invention.

The server 103 tokenizes the user search 201 into one or more tokens 300. The user search 201 may be a domain name, string of characters, a string of words, and/or some combination thereof. The tokenization process preferably begins by parsing the user search 201 into a plurality of words or character strings. In the example from FIG. 2, the words and character strings found may be “Ice,” “Cream,” “Factory,” “24,” “Hours,” and “Healthy.” Domain names are not case sensitive, thus either capital or non-capital letters may be used for the words, entities, and/or tokens 300 depending on visual preference.

In another embodiment, the user 100 does not have to enter a user search 201 for a plurality of tokens 300 to be generated and displayed. As an example, information may be found, preferably online or in one or more proprietary databases, that is associated with the user 100 and this information may be used to generate a plurality of tokens 300 associated with the user 100. As another option, a keyword spinner may be used to generate a plurality of tokens 300 using any known, or later developed, method of spinning words. As non-limiting examples, the user search 201 and/or tokens 300 may be generated and displayed by combining various subcombinations and combinations of words associated with the user 100, random words, words that have been selected in the past by the same or different users 100, the user's name, address or location, associated businesses’ names, past purchases, social media handles or data, data from proprietary databases, hobbies, or any other online personal, recreational, business, and/or professional information.

Adjacent or neighboring words and character strings in the user search 201 may be examined to determine how often the words appear next to each other in general use. This may be accomplished by searching for the word combinations in one or more online or proprietary databases. Groups of words and character strings that appear next to each other frequently may be consider an entity and be assigned to a single token 300. In the current example, the entity “Ice Cream” and “24 Hours” may be discovered. The tokens 300 may remain “Ice,” “Cream,” “24,” and “Hours,” but are preferably reformatted to “Ice Cream” 301 and “24 Hours” 303.

Prepositions, pronouns, articles, stop words, etc. (that are not part of an entity) may be removed from consideration. The remaining words (“Factory” and “Healthy”) and entities (“Ice Cream” and “24 Hours”) may be considered tokens 300 and prioritized. The prioritization may be based, as non-limiting examples, on how often the words or entities have been selected for domain name registration in the past or by the order the words and entities were entered into the data entry field, i.e. from left to right.

While any number of tokens 300 may be used, in a preferred embodiment only four tokens 300 or less, having the highest priority, are used. Thus, as shown in FIG. 3, the tokens 300 in the current example, prioritized in the order the words were entered into the data entry field 200, are “Ice Cream” 301, “Factory” 302, “24 Hours” 303, and “Healthy” 304. (Step 1010)

For each token 300, zero or more corresponding keywords 400 may be found. The keywords 400 may be, as non-limiting examples, synonyms, related words, commonly purchased together words, experimental words, associated in a database, determined by analysis of domain name search logs, determined to have grammatical similarities, i.e. parts of speech, associations through search engines, thesauruses, and/or found using synonym generators with one of the tokens 300. (Step 1020)

In one embodiment for selecting keywords 400, previous domain name search logs may be analyzed. For example, if domain names containing “Ice Cream” were unavailable and past users 100 consistently selected alternative domain names containing “Gelato,” then “Gelato” would preferably be made one of the keywords 400 associated with the token “Ice Cream.”

The keywords 400 are preferably prioritized and listed in their order of priority under each token with the highest priority keywords 400 being placed at the top of the list. Higher priority keywords 400 may be made a different color, font, size, bold, highlighted, background, etc. or placed in a tag cloud to encourage the selection of the higher priority keywords 400. The keywords 400 may be ranked, as non-limiting examples, based on the number of users 100 that have selected the keyword 400 in the past, past domain name selections and/or domain names registered that contain the keyword 400. This criteria can be further broken down, for example, by prioritizing keywords 400 in registered domain names above keywords in domain names only selected for registration, but where the user 100 never finished the registration process for the domain name. In another embodiment, the keywords may be presented in a tag cloud, near their associated token, for selection, with higher priority keywords larger or made more prominent than lower priority keywords.

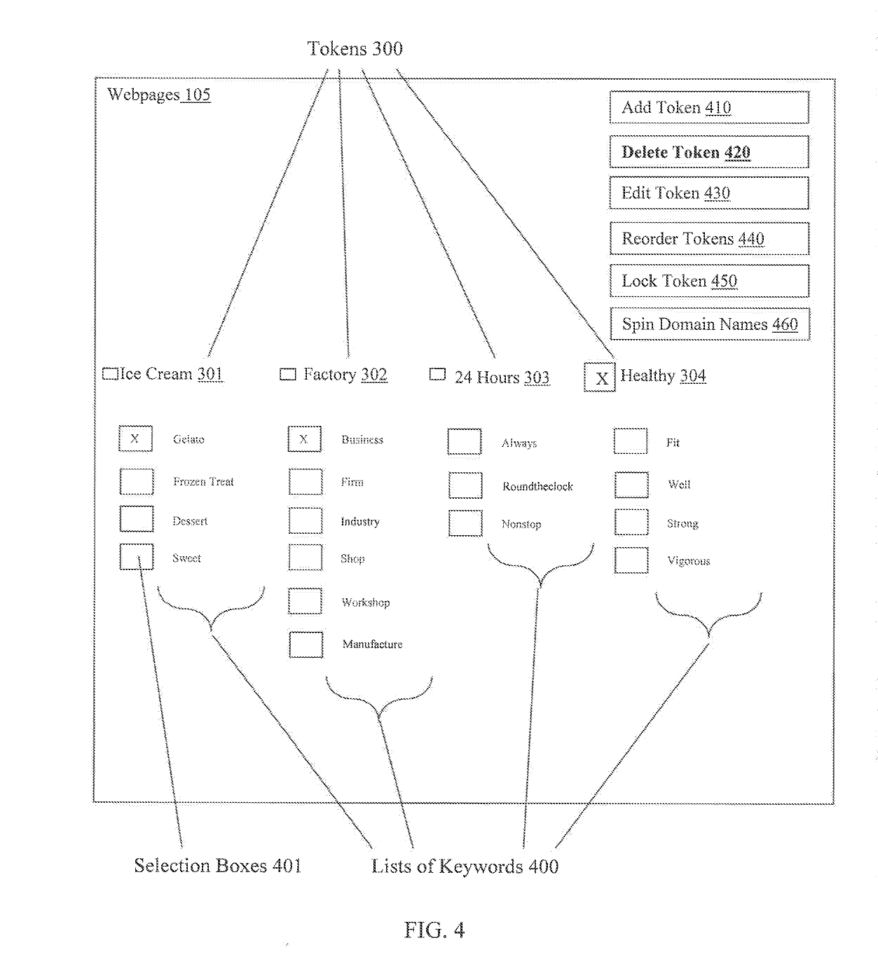

The tokens 300 and keywords 400 may be arranged in lists, with each token and the token's associated keywords 400 forming a list, and displayed on a webpage 105 as shown in FIG. 4. The lists are preferably arranged in order of priority, as previously determined, with the highest priority token 300 farthest to the left and the lowest priority token 300 farthest to the right on the webpage 105. In the illustrated example, the tokens 300 “Ice Cream” 301, “Factory” 302, “24 Hours” 303, and “Healthy” 304 are arranged in that order, from left to right, as that was the order of priority the tokens 300 received based on the order the tokens 300 were entered into the data entry field 200 by the user 100.

While not shown in the embodiment illustrated in FIG. 4, a list, preferably on the right side of all the tokens 300, may be displayed showing domain name extensions or TLDs. In this embodiment, the user 100 may select one or more domain name extensions to use in spinning domain names. Alternatively, the domain name extensions may also be selected based on the user search 201, selected keywords 400 and/or tokens 300.

The user 100 may decide to add another token 300, delete a token 300, edit a token 300, reorder tokens 300, lock a token 300, select zero or more keywords from each displayed list, select zero or more domain name extensions, and/or decide to spin a new batch of available domain names (or social media handles) based on the currently displayed tokens 300. (Step 1040) Any of these actions may be taken without the user 100 having to reenter the user search 201, thereby greatly simplifying the process of spinning domain names for the user 100 since the user 100 only has to enter the user search 201 one time (although the user 100 could enter a new user search 201 if the user 100 so desired.)

While specific buttons (“Add Token” 410, “Delete Token” 420, “Edit Token” 430, “Reorder Tokens” 440, “Lock Token” 450, and “Spin Domain Names” 460) are displayed on the webpage 105 in FIG. 4, it should be understood that any known, or developed in the future, method may be used to allow the user 100 to indicate the user's 100 desires, such as to manipulate the tokens 300 or perform various functions on the webpage 105. As non-limiting examples, fixed menus, pull-down menus, radio buttons, tabs, bars, left or right mouse clicks, pulling or dragging icons, text entry boxes, check boxes, soft buttons, touch screens, voice activation or commands, and/or any other method for manipulating the tokens 300 or initiating an action may be used by the user 100.

Delete a Token

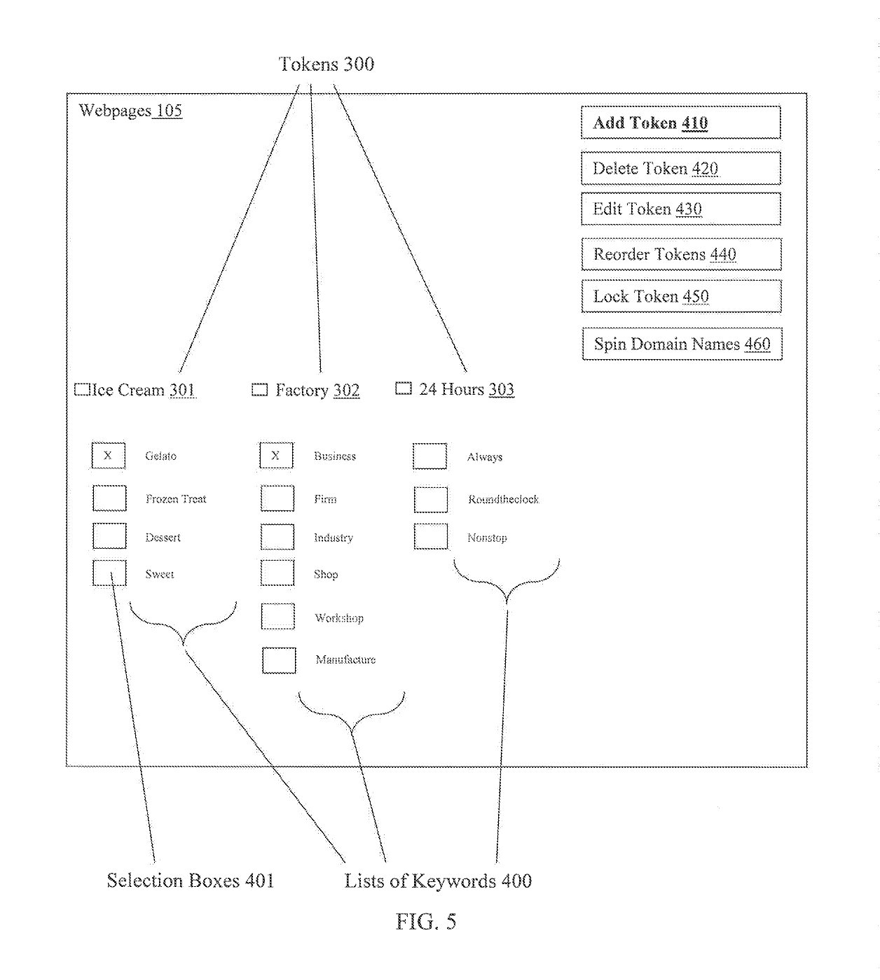

The user 100 may decide to delete one of the active and displayed tokens 300. For example, the user 100 may decide to delete, i.e., not use, the token 300 “Healthy” 304 in spinning new domain names (or social media handles). In such a situation, the user 100 may provide an indication that the user 100 desires to delete one of the tokens 300. As one possible non-limiting mechanism for deleting a token 300, the user 100 may place a check in a box in front of the token 300 desired to be deleted (in this case “Healthy” 304) and select the “Delete Token” 420 button. As another non-limiting example, the text “Health” 304 may be dragged to a trash can icon (not shown) using a mouse, stylus, or touch screen. As another non-limiting example, the text “Health” 304 may be right clicked on causing a menu to appear that includes the option to delete the token 300. After deleting the token “Health” 304, the webpage 105 may be automatically updated by the server 103 to reflect that the token 300 “Healthy” 304 is no longer active, i.e, the token “Healthy” 304 and its associated keywords 400 may be removed from the webpage 105. FIG. 5 illustrates the webpage 105 after the token 300 “Healthy” 304 has been deleted.

Add a Token

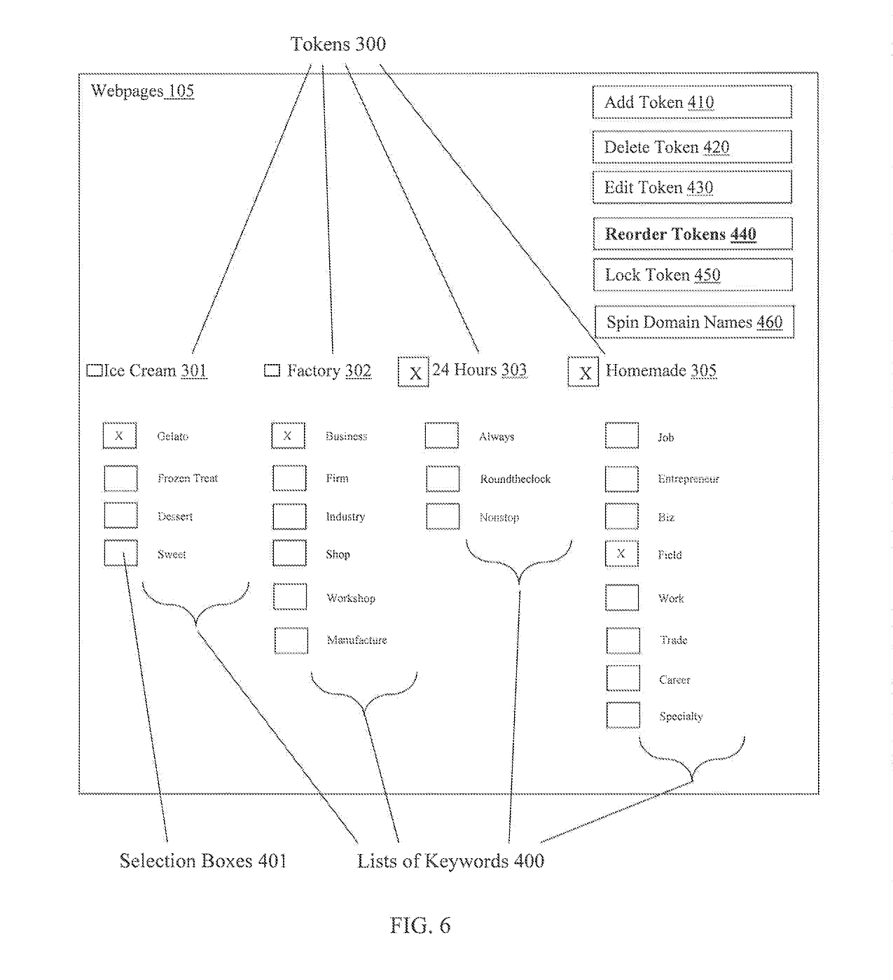

The user 100 may decide to add a new token and, optionally, the order of the new token 300 in relation to the existing tokens 300, For example, the user 100 may decide to add the token 300 “Homemade” 305 to the end of the list of tokens 300 illustrated in FIG. 5. The user 100 may provide an indication that the user 100 desires to add the new token 300 using any known, or later discovered, method in the art. As non-limiting examples, the new token may be verbally entered, the user 100 may click on a position at the start, end, or in between tokens 300 and enter the new token, or the user 100 may select the “Add Token” 410 button and enter a token 300 in a data entry field created for this purpose. As a specific example, the user 100 may enter “Homemade” 305 in a data entry field. The webpage 105 may be automatically updated to reflect that a new token “Homemade” 305 has been added. FIG. 6 illustrates the webpage 105 after the token 300 “Homemade” 305 has been added to the right of the other active tokens 300, although, in a preferred embodiment, the new token may be added to any position of the tokens 300.

Reorder Tokens

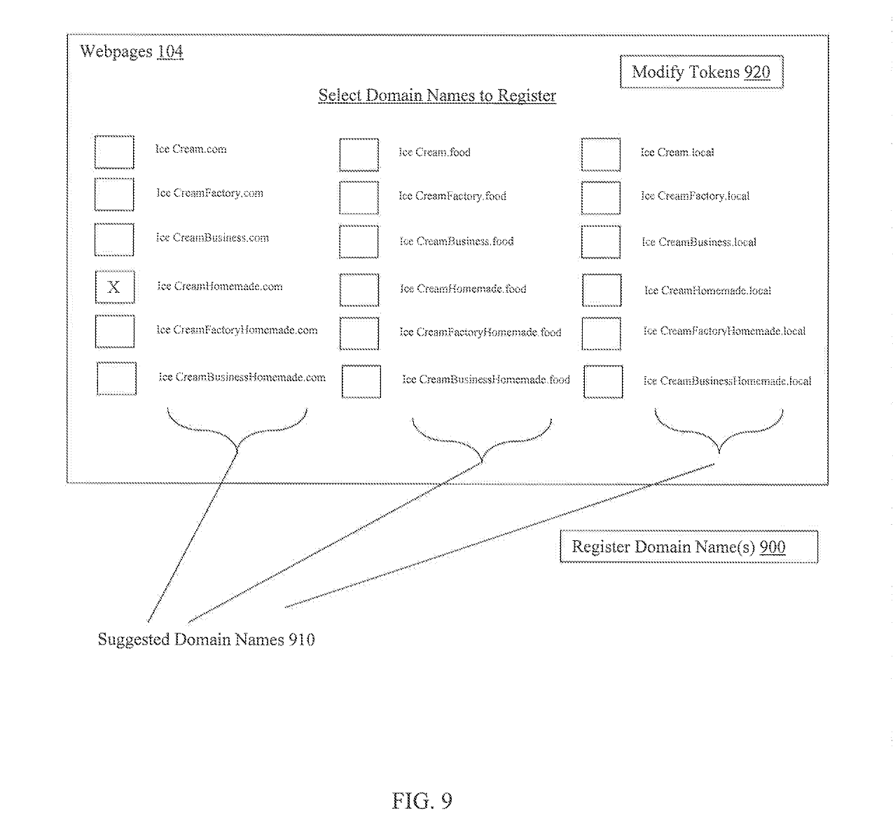

The user 100 may decide to reorder the tokens 300, which also has the effect of reordering the lists of keywords. For some embodiments, the ability to reorder tokens 300 is important since the created suggested domain names 901, shown in FIG. 9, are preferably created by concatenating selections from the lists from left to right. This means, in certain embodiments, tokens 300 or keywords that appear to the left on webpage 105 will be to the left of tokens 300 or keywords that appear to the right on webpage 105 in all suggested domain names 901 (or social media handles). This embodiment allows the user 100 to control the order of the tokens 300 and selected keywords 400 as they appear in the created and suggested domain names 901 (or social media handles).

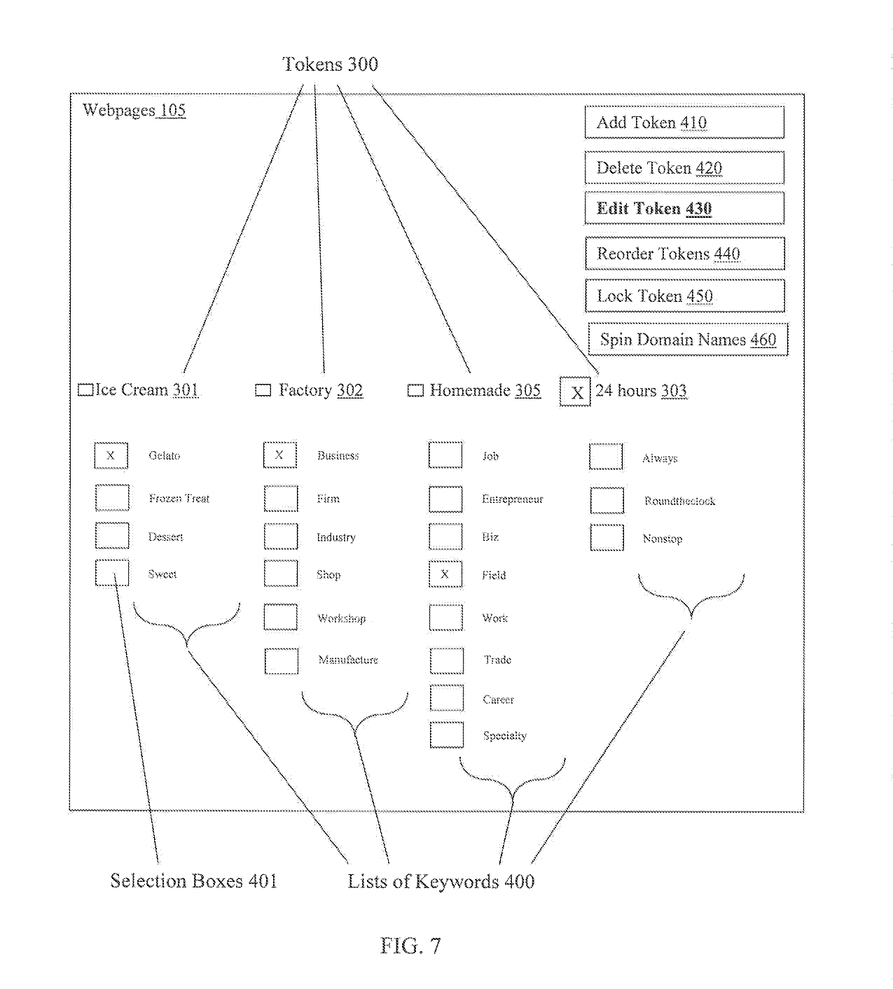

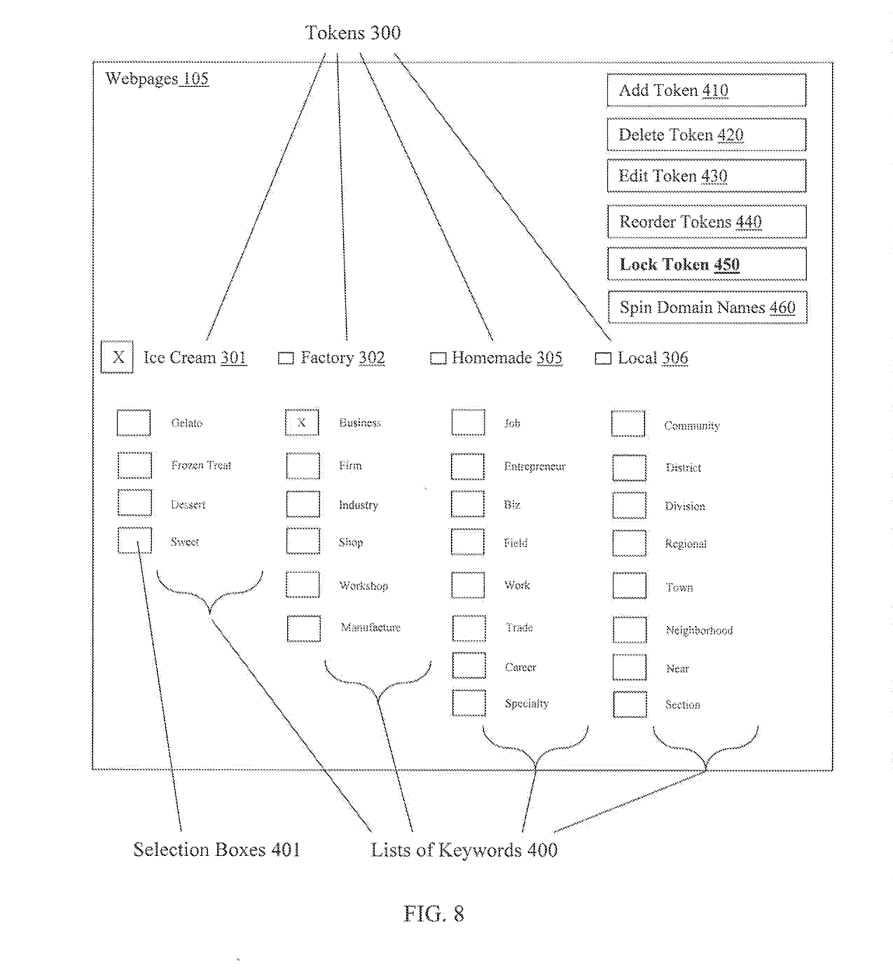

The user 100 may provide an indication that the user 100 desires to reorder one or more tokens 300 (and thus the tokens' 300 associated keywords 400) using any known, or later developed, method. As one non-limiting example, the user 100 may drag and drop a token 300 into a new position (such as between two other existing tokens 300). in another non-limiting example, the user 100 may place a check mark in front of boxes in front of tokens 300 that are desired to be reordered. This is illustrated in FIG. 6. A check has been placed in front of “24 Hours” 303 and in front of “Homemade” 305. The user 100 may then select the “Reorder Tokens” 440 button to cause the two tokens 300 to be reordered (switched in this example) as illustrated in FIG. 7.

Edit Token

The user 100 may decide to edit one of the tokens 300. The user 100 may provide an indication that the user 100 desires to edit a token using any known, or later developed, method. As one non-limiting example, the user 100 may click on the token desired to be edited and edit the text of the token. The edited token may differ from the original token by a single character, the edited token may be an entirely different word or entity, or anything in between. Preferably, the editing process is similar to that performed in word processing applications.

After receiving the edited token, zero or more corresponding keywords 400 may be found. The keywords may be, as non-limiting examples, synonyms, categorically related, associated in a database, determined by analysis of domain name search logs, determined to have grammatical similarities, i.e. parts of speech, associations through search engines, thesauruses, and/or found using synonym generators with the edited token. A new list may be created for the edited token and its corresponding keywords. This new list with the edited token and new corresponding keywords may be automatically displayed on the webpage 105, while the list of the token before it was edited is preferably deleted and no longer displayed on the webpage 105. FIG. 8 shows a possible result after the token “24 Hours” 303 was edited to be “Local” 306 from FIG. 7.

Lock Token

The user 100 may decide to lock one or more of the tokens 300. This option allows the user 100 to be sure that every suggested domain name or social media handle will include the locked token(s) 300. The user 100 may provide an indication that the user 100 desires to lock a token 300 using any known or later developed method of entering data into a webpage 105. As one non-limiting example, FIG. 8 illustrates how the user 100 may place a check mark in front of a token 300 (in this example “Ice Cream” 301) and then selects a “Lock Token” 450 button. As another non-limiting example, there may be a box or selection feature for each token that may be selected to indicate that one or more of the tokens 300 is locked. Optionally, locked tokens 300 may be marked, such as by changing the color of their text, size of their font, using bold text, or by other visual methods.

Select Keywords

The user 100 may select zero or more keywords from each token's list of keywords using any known, or latter developed, method. The keywords 400 may be concatenated together with tokens 300 and/or keywords from other lists in subcombinations and combinations to form suggested domain names 901 or social media handles during the spinning process. A limit may be placed on the number of keywords 400 that the user 100 may select from each list to prevent the number of possible name identifiers (permutations) to become too burdensome to create and verify availability.

Select Domain Name Extension(s)

The user 100 may also have the option of selecting one or more domain name extensions in a manner similar to that used to select tokens 300 and keywords 400. This allows the user 100 to be sure that every suggested domain name will have one of the user's 100 selected domain name extensions. In another embodiment, the system may determine, based on the tokens 300, selected keywords, historical data, purchase logs, online information, proprietary databases, user location_{;} etc. which domain name extensions should be used for the suggested domain names 901. (Step 1060) As an example, the created domain names in FIG. 9 assume that the domain name extensions “.com,” “.food,” and “.local” where selected by the user or determined by the server 103.

Spin Name Identifiers

The user 100 may provide an indication, using any known, or developed in the future, method that the user 100 wishes to view one or more available name identifiers (such as, as non-limiting examples, domain names or social media handles) based on subcombinations and combinations of the selected tokens 300 and keywords 400. The user 100 may spin, i.e. create a new batch of domain names, preferably after the user 100 has the desired tokens 300, in the desired order, selected the desired keywords, and/or locked the desired tokens 300/keywords as many times as desired. As one non-limiting example, the user 100 may select a “Spin Domain Names” 460 button when ready to spin for more domain names. (Step 1050)

A plurality of name identifiers, such as domain names or social media handles, may be created by concatenating various subcombinations and combinations of the tokens 300, the selected keywords 400, and/or the selected or determined domain name extensions. (Step 1080)

In a preferred embodiment, only one token 300 or keyword 400 from each list is used in a single domain name or social media handle. This helps prevent two or more synonyms appearing in the same name identifier. Another option is to allow only one synonym (even if the synonyms appear from different token lists) in the same name identifier. This option can include considering domain name extensions in the synonym analysis, i.e. a token or keyword that is a synonym of a domain name extension would not be used in the same domain name with the domain name extension. (Step 1070) The non-used synonym token(s), keyword(s), and/or domain name extension(s) may still be used in different domain names, just not together in the same domain name or social media handle.

Control Order of Tokens in Suggested Name Identifiers

Another option is to retain the order of the tokens 300 and keywords 400 in the created domain names or social media handles. As an example, the order of the tokens 300 in FIG. 8, from left to right, is “Ice Cream” 301, “Factory” 302, “Homemade” 305, and “Local” 306. Thus, the token “Ice Cream” 301 would never appear to the right in a suggested name identifier of the tokens 300 “Factory” 302, “Homemade” 305, or “Local” 306 while “Factory” 302 would never appear to the right in a suggested name identifier of the tokens 300 “Homemade” 305 or “Local” 306. This left to right ordering would apply to all the tokens 300 and selected keywords 400. This embodiment allows the user 100 a great deal of control over the order of the tokens 300 and keywords 400 in the suggested name identifiers 910.

Check Availability of Name Identifiers Before Displaying

After the plurality of name identifiers has been created, each name identifier may be checked, such as by checking with the Registry 107 or social media platform, comparing the name identifier against recent zone files, or by other known, or developed in the future, methods to see if each name identifier is available for registration. Unavailable name identifiers may be removed from the plurality of created name identifiers since these name identifiers would only obscure the presence of available name identifiers and confuse the user 100. (Step 1090)

The created available name identifiers 910 may be prioritized. Names identifiers 910 that are thought to be more valuable or higher quality (generally shorter and more general domain names or social media handles) may be displayed more prominently, such as at the beginning of a list. The name identifiers 910 may also be prioritized based on the order of the tokens 300 and keywords 400, with tokens 300 and keywords 400 to the left having a higher priority than tokens 300 or keywords 400 to the right. (Step 1100)

The created available name identifiers 910 (in this case domain names) may be displayed as shown on webpage 104 in FIG. 9. In this example, the domain name extensions “.com,” “.food,” and “,local” have been selected. The domain names 910 in FIG. 9 are shown for illustrative purposes and have not actually been checked for availability like the domain names would be in a preferred embodiment. (Step 1110)

The user 100 may indicate on the webpage 104 that the user 100 desires to register zero or more of the displayed name indicators 910. In FIG. 9, each displayed domain name is provided a check box, but any known, or later discovered, method for selecting items in one or more lists may be used by the user 100 to select zero or more name identifiers 910. (Step 1120) The user 100 may also return to a webpage 105 that allows further modifications of the tokens 300 and keywords 400 by any known, or developed in the future, method of moving between webpages 105 of a website 104. As an example, the user 100 may select the “Modify Token” 920 button to return to a webpage 105 that allows the user 100 to make further modifications to the tokens 300 and keywords 400.

If the user 100 has indicated that the user 100 would like to register one or more of the domain names 910, the selected domain names may be register to the user 100 over the computer network 102 with a Registry 107. (Step 1130) In the non-limiting example provided in FIG. 9, the user 100 may select a domain name by placing an X in the box next to the domain name and then selecting the “Register Domain Name(s) 900 button. In the example, the domain name “Ice CreamHomemade.com” is selected, but any number of different domain names may be selected using this method. The additional steps in registering the selected domain name(s) with a Registry 107 are well known (such as getting the contact and payment information of the user 100) and will not be discussed to avoid obscuring the invention with these well known processes. A similar process may be used to register a social media handle with a social media platform.

Whether or not the user 100 registers one or more name identifiers 910, the user 100 may return to the webpage 105 shown in FIG. 8 to make further modifications to the tokens 300 and the selected keywords 400. This allows the user 100 to easily create and see, i.e. spin, many more available name identifiers merely by making adjustments to the selected tokens 300 and keywords 400. This process has the advantage over previous methods by removing the step of forcing the user 100 to reenter the user search 201 prior to every name identifier search. This powerful process allows the user 100 to easily zero-in on the best possible name identifier for the user 100.

Positioning Suggested Domain Name(s)

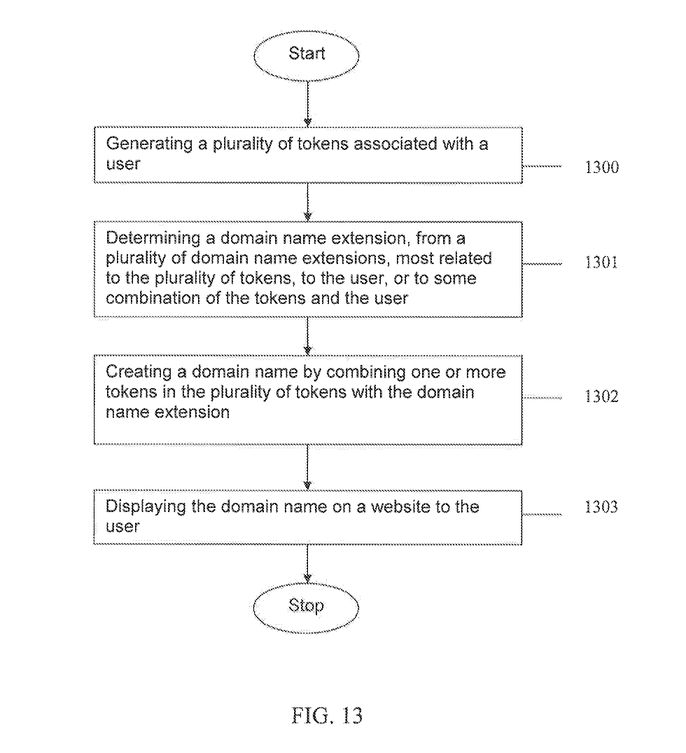

Another embodiment will now be discussed with reference to FIG. 13. In this embodiment, a plurality of tokens 300 associated with a user 100 may be generated by any method or as disclosed above. (Step 1300) As specific, non-limiting examples, the tokens 300 may be generated from a user search 201, from public and/or private information associated with the user 100, from experimental or frequently selected tokens 300, from a keyword spinner and/or synonyms/related words to any of the above,

The most closely related domain name extension to the plurality of tokens 300 may be determined, (Step 1301) The Internet Corporation for Assigned Names and Numbers (ICANN) defines policies that control domain name extensions. While the number of domain name extensions is growing (there are currently over 300), the number of domain name extensions is finite. Those familiar with the art will know how to find domain name extensions that are recognized by ICANN. While the invention may be used with all the domain name extensions recognized by ICANN, some embodiments may only operate on a subset of domain name extensions.

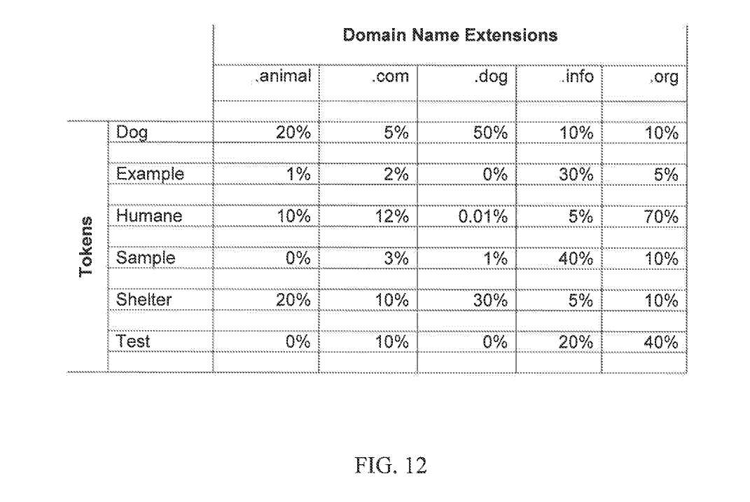

FIG. 12 represents, as a non-limiting example, a database that may be used to practice the invention. A database is an organized collection of data. The data are typically organized to model relevant aspects of reality in a way that supports processes requiring this information. Database management systems (DBMSs) are specially designed applications that interact with the user 100, other applications, and the database itself to capture and analyze data. A general-purpose database management system (DBMS) is a software system designed to allow the definition, creation, querying, update, and administration of databases. As non-limiting examples, DBMSs may include MySQL, MariaDB, PostgreSQL, SQLite, Microsoft SQL Server, Oracle, SAP, dBASE, FoxPro, IBM DB2, LibreOffice Base and FileMaker Pro.

The data in FIG. 12 reflects an illustrative sample of a plurality of domain name extensions (.animal, .com, .dog, .info, and .org) with a corresponding determined amount of relatedness for each token with an illustrative sample of a plurality of tokens 300 (Dog, Example, Humane, Sample, Shelter, and Test). Of course in practice, any number and combination of domain name extensions and tokens 300 may be used and will generally contain much more data. The small database shown in FIG. 12 is shown for illustrative purposes only, and actually databases will generally be much larger.

The terms related and relatedness should be construed broadly and mean a compatibility, similarity, affinity, high frequency of appearing together, and/or association in some manner. While the relatedness data in the database illustrated in FIG. 12 is stated as a percentage, the invention is not so limited and any quantitative or other type of scale may be used to indicate different levels of relatedness.

In one embodiment, the relatedness of the tokens 300 to the domain name extensions are determined by parsing all past registered domain names (or domain names registered within a given time period, preferably over a recent time period to keep the data relevant with current trends) and comparing the frequency a given token in a registered domain name is found with a particular domain name extension. Tokens 300 frequently found with a particular domain name extension are preferably assigned a high relatedness for that domain name extension, while tokens 300 infrequently found with the particular domain name extension are preferably assigned a low relatedness for that domain name extension. The results of the parsing of the domain names may be scaled and/or normalized before saving in a database, such as that shown in FIG. 12.

In addition to past registered domain names, other databases may be scanned to determine the relatedness of particular tokens 300 to domain name extensions.

Also, while the database in FIG. 12 illustrates only tokens 300 that are single words, the database is not so limited, and may also include tokens 300 that comprise a plurality of words, entities, and/or n-grams. Further, while the database may be used to rapidly determine a relatedness of tokens 300 to domain name extensions, other embodiments permit the invention to calculate a relatedness of one or more tokens 300 to one or more domain name extensions in real time.

As specific examples from the database illustrated in FIG. 12, the token “Dog” has been determined to be related to the domain name extension “.animal” by 20%, “.com” by 5%, “.dog” by 50%, “.info” by 10%, and “.org” by 10%. Each of the other tokens 300, i.e., “Example,” “Humane,” “Sample,” “Shelter,” and “Test” are also provided a percentage of relatedness for the same list of domain name extensions.

A plurality of domain name extensions may be ranked for a given one or more tokens 300 using any mathematical technique. As non-limiting examples, the plurality of domain name extensions may be ranked by adding, averaging, or accepting the highest relatedness for each of the one or more tokens 300 for each domain name extension in the plurality of domain name extensions.

As an example, the tokens 300 “Humane” and “Shelter” may have been generated for a user 100. Using the data in FIG. 12, tokens 300 “Humane” and “Shelter” may be determined to have a relatedness for the domain name extension “.com” to be “Humane” 12%+“Shelter” 10%=22%. The tokens 300 “Humane” and “Shelter” may be determined to have a relatedness for the domain name extension “.dog” to be “Humane” 0.01%+“Shelter” 30%=30.01%. Thus, for the tokens 300 “Humane” and “Shelter,” the domain name extension .com has a relatedness of 22% while the domain name extension .dog has a relatedness of 30.01%. In this example, the domain name extension .dog (30.01%) would be ranked higher than the domain name extension .com (22%). While the relatednesses were added in this example, other methods may also be used. A plurality of domain name extensions may be ranked in this manner based on the calculated relatedness of the tokens 300 for each domain name extension in the plurality of domain name extensions.

Not only can domain name extensions have a relatedness for a token or a plurality of tokens 300, but domain name extensions can also have a relatedness to a user 100. The relatedness of one or more domain name extensions to the user 100 may be determined using any method of determining relatedness and, for illustrative purposes, may be determined by using one or more of the following examples and factors.

As a non-limiting example, the current location of the user 100, billing location, or any other location information associated with the user 100 (location factors) may be used to determine the relatedness of one or more domain name extension to the user 100.

As another non-limiting example, categories or fields of interest (e.g., automobiles, botany, child development, history, religion, rifles or self help), hobbies (e.g., astronomy, cooking, chess, crochet, gardening, hunting, photography, sports, stamp collecting or wood working), professions (e.g., accountant, attorney, agriculture, auto repair, civil engineer, construction, dentil, graphical designer, medicine, mining, psychology or teacher/professor), category/vertical of business (e.g., architect, fast food, house cleaning, manufacturer or real estate) or expertise (e.g., computer programming, mathematics, metallurgy or website designer) of the user 100 may be used to determine the relatedness of one or more domain name extensions to the user 100.

As another non-limiting example, a domain name extension's relevance to the user 100 (e.g., such as to the location of the user 100, interest of the user 100, hobbies of the user 100, profession of the user 100, business of the user 100, and/or expertise of the user 100) may be used to determine the relatedness of one or more domain name extensions purchased by the user 100,

As another non-limiting example, business factors, such as the number of years for registration of domain name extensions or that increase domain name registrations and/or customers may be used to determine the relatedness of one or more domain name extensions to the user 100.

As another non-limiting example, site factors, such as which site the user 100 is currently using and/or has used in the past may be used to determine the relatedness of one or more domain name extensions to the user 100.

As another non-limiting example, pricing factors, such as current price, sale price, renewal price, etc. may be used to determine the relatedness of one or more domain name extensions to the user 100.

As another non-limiting example, the user's 100 preference, implicit and/or explicit, such as those determined from past purchases and/or browsing behaviors, or past purchases and/or browsing behaviors from users similar to the user 100 may be used to determine the relatedness of one or more domain name extensions to the user 100.

As another non-limiting example, social factors, such has social media handles' availability for combinations of tokens 300 with the domain name extensions, may be used to determine the relatedness of one or more domain name extensions to the user 100.

As another non-limiting example, traffic factors such as Search Engine Optimization (SEO), Search Engine Marketing (SEM), CPM rates (Cost per 1000 impressions of advertising displayed on the domain name), etc, may be used to determine the relatedness of one or more domain name extensions to the user 100.

Another way for domain name extensions to improve their ranking is to receive a payment to rank a particular domain name extension higher within a plurality of domain name extensions.

While a plurality of domain name extensions may be ranked based solely on a payment for ranking, solely on a relatedness to generated tokens 300, or solely on a relatedness to a user 100, in a preferred embodiment, two or more of these factors are blended together to rank the plurality of domain name extensions. These factors may be normalized, added, averaged, combined, merged, and/or weighted. The weighting of one or more of these factors allows some of these factors to be more or less determinative (based on the weighting) to the ranking of the plurality of domain name extensions than other factors.

Another exemplary method is disclosed in FIG. 13 for suggesting a domain name on a website 104 for a user 100 to register. The domain name or domain name extension selected for suggesting to the user 100 may be based on the relatedness of the domain name's corresponding domain name extension with one or more tokens 300, with the user 100, or some combination of relatedness to the tokens 300 and the user 100. In this embodiment, a plurality of tokens 300 may be generated that are associated with a user 100. (Step 1300) A plurality of domain name extensions may be analyzed to determine the domain name extension that is most related to the plurality of tokens 300, to the user 100, or to some combination thereof. (Step 1301) A domain name may be created by combining one or more tokens 300 in the plurality of tokens 300 with the domain name extension that is most related to the plurality of tokens 300, to the user 100, or to some combination thereof. (Step 1302) The domain name may then be displayed on the website 104 for the user 100 to select at the users 100 discretion. (Step 1303) The selected domain name may be registered to the user 100.

This embodiment may also allow the user 100 to manipulate the tokens 300 on the website 104. In addition, the availability of the domain name may be checked and only displayed on the website 104 to the user 100 if the domain name is available for registration.

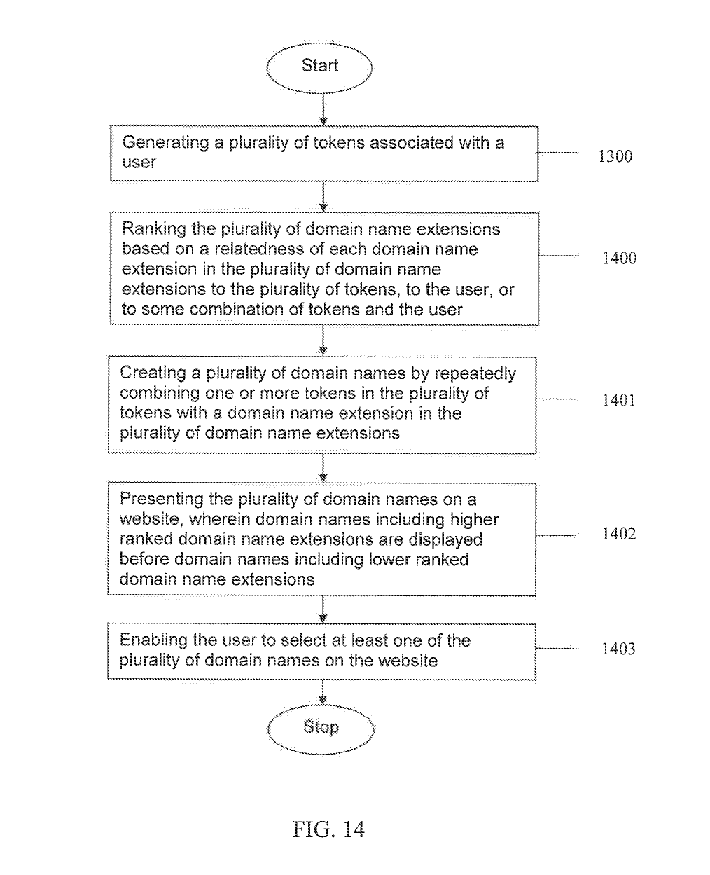

Another exemplary method is disclosed in FIG. 14 for positioning suggesting domain names on a website 104 for a user 100 based on the relatedness of the domain names' corresponding domain name extensions with one or more tokens 300, with the user 100, or with some combination thereof. In this embodiment, a plurality of tokens 300 associated with the user 100 may be generated. (Step 1300) A plurality of domain name extensions may be ranked based on a relatedness of each domain name extension with the plurality of tokens 300, with the user 100, or some combination thereof. (Step 1400) A plurality of domain names may be created by repeatedly combining one or more tokens 300 in the plurality of tokens 300 with a domain name extension in the plurality of domain name extensions. (Step 1401) Preferably, only top ranked domain name extensions are used to create the plurality of domain names. The domain names that have higher ranked domain name extensions may be presented to the user 100 on the website 104 before domain names that have lower ranked domain name extensions. (Step 1402) The user 100 may then select on the website 104 one or more of the presented domain names for registration. (Step 1403)

As in prior embodiments, this embodiment may also allow the user 100 to manipulate the tokens 300 on the website 104. In addition, the availability of the created domain names may be checked prior to being displayed, and only the available domain names are displayed on the website 104 to the user 100 for registration.

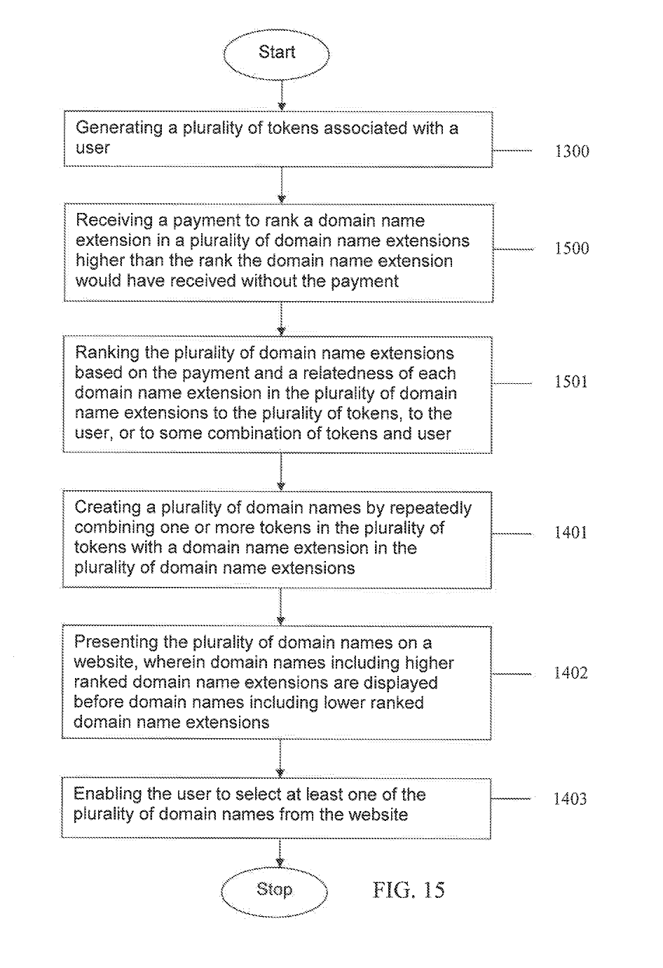

Another exemplary method is disclosed in FIG. 15 for positioning suggested domain names 901 on a website 104 for a user 100 based on a payment received and/or a relatedness of the domain names' corresponding domain name extensions with one or more tokens 300, with the user 100, or some combination thereof. Domain names that have been at least partially ranked based on a received payment may be presented to the user 100 on the website 104 in the same manner as domain names that have not been ranked based on a received payment. However, in a preferred embodiment, domain names that have been at least partially ranked based on a received payment are presented to the user 100 on the website 104 in a different manner than domain names that have not been ranked based on a received payment. For example, the font type, font size, font color, font style, font background, font highlighting, font positioning, or any other user interface change on the website 100 may be used to distinguish domain names that have been at least partially ranked based on a received payment from domain names that have not been ranked based on a received payment.

In embodiments that include a received payment, a plurality of tokens 300 associated with a user 100 may be generated. (Step 1300) A payment to after the ranking of a domain name extension, in the plurality of domain name extensions, may be received, (Step 1500) The plurality of domain name extensions may be ranked based on the payment received and/or the relatedness of each domain name extension with the plurality of tokens 300, with the user 100, or some combination thereof. (Step 1501) A plurality of domain names may be created by repeatedly combining one or more tokens 300 in the plurality of tokens 300 with a domain name extension in the plurality of domain name extensions. (Step 1401) Preferably, only top ranked domain name extensions are used to create the plurality of domain names, The domain names that have higher ranked domain name extensions may be presented to the user 100 on the website 104 before domain names that have lower ranked domain name extensions. (Step 1402) The user 100 may then select on the website 104 one or more of the suggested domain names 910 for registration. (Step 1403)

This embodiment may also allow the user 100 to manipulate the tokens 300 on the website 104. In addition, the availability of the created domain names may be checked prior to being displayed, and preferably only the available domain names are displayed on the website 104 to the user 100.

Positioning Suggested Domain Names Based on Term Frequency and/or Term Co-Occurrence.

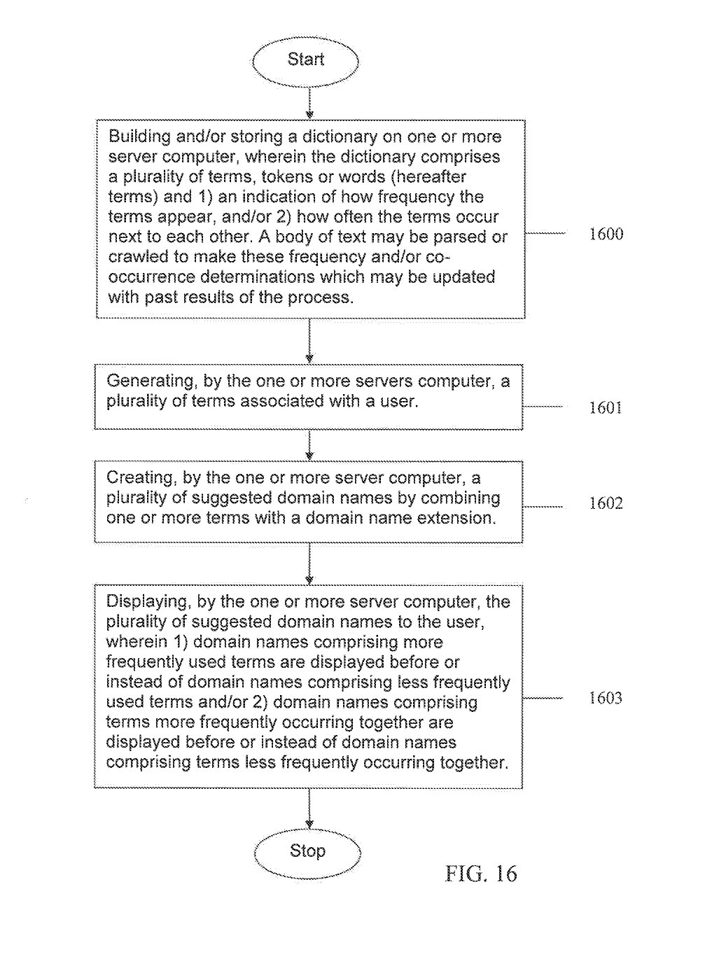

Another embodiment is illustrated in FIG. 16. In this embodiment various entity sources and/or one or more bodies of text (e.g., domain name search/selection and/or registration logs, search engines request logs, Wikipedia, standard language dictionaries, websites, external sources and/or databases, etc.) may be crawled to compile a list of words, terms and/or phrases (hereafter terms) that comprise new, unfamiliar, product-specific (e.g., “kindle,” “iPad”) terms or that occur together (e.g., “mickey mouse,” “ice cream,” etc.) These frequently used and/or co-occurring terms may be stored as a language dictionary that compiles the terms that may be stored in a database. How frequently these terms appear within a text body, selected and/or registered domain names and how frequently two or more of these terms appear together (co-occurrence) in a text body or in selected and/or registered domain names may also be stored in the dictionary.

A single dictionary may cover different markets, countries and/or languages or a plurality of dictionaries may be used, with each dictionary representing a different market, country and/or language. Any number of dictionaries may be used with each dictionary directed towards any number of different markets, countries and/or languages.

A co-occurrence pair of terms may have a different score and/or rank in different markets, countries and/or language dictionaries. For example, the terms “Mickey” and “mouse” may have a high score in an English dictionary and a low score in a Russian dictionary, while “Mikki” and “maus” may have a high score in a Russian dictionary and a low score in an English dictionary.

Similarly, the score and/or rank for the same pair may be different in different markets, For example, the terms “taxi” and “limo” may be ranked high in a United States dictionary and low in a United Kingdom dictionary, while “taxi” and “car” may be ranked lower in the United States dictionary, but higher in the United Kingdom dictionary.

The dictionary is preferably designed for domain name spinning rather than for general purposes (e.g., English language dictionary). Terms within the dictionary may be “specialized,” that is associated in the database with variants for markets (e.g., brands), countries and/or languages (e.g., UK, US, Australian English). Languages, countries and markets may be determined via IP addresses, domain string requested, etc. The terms may also be used to select domain name extensions. (Step 1600)

A server computer running appropriate software to create a webpage on a website may receive a query string from a user as previously described with reference to FIG. 2. As non-limiting examples, the server computer may receive “mickeymouseicecream,” “michaelicefactory,” or “kindlebooksstarwars.”

The server computer may identify one or more terms in the received query string. For example, the query string “michaelicefactory” may be parsed and one or more terms in the dictionary may be identified. Specifically, michae (start 1, length 6), michael (start 1, length 7), lice (start 7, length 4), ice (start 8, length 3), fact (start 11, length 4) and factory (start 11, length 7) may all be found. In addition, terms associated with the user may be determined as previously described. (Step 1601)

A finite state machine, consisting of a graph, may compare the received string with comparable data from the dictionary. In the “mickeymouseicecream” example, “m” is the root path, with nodes for “i,” “c,” “k,” “e,” “y,” etc. As long as the language dictionary has a comparable path (e.g., “m,” “i,” “c,” “k,” “e,” “y,” etc.), the state machine continues. When the state machine identifies a recognized word (e.g., “mickey”), the state machine may use the following letter (e.g., “m”) to determine whether to continue. As another example, perhaps the next letter after “mickey” is “e”. If the dictionary has a node to “eye,” the state machine may continue to determine if “eye” is the next term after “mickey.” If the state machine does not find an “m” or “e” after “mickey” in the received string (or any other letter that has a node attached after “mickey”), the state machine may stop at this point and identify “mickey” as a term.

As more and more sources are added to the dictionary, more options may be available after the “y” in “mickey”. The state machine may also determine “strong” (i.e., higher probability matches) nodes after completed words (e.g., “m” for “mouse” is probable after “mickey,” “k” for “kangaroo” is much less probable). The state machine may determine that the stronger the node, the more likely that the two words belong together in suggesting domain names. Thus, domain names with stronger nodes are shown more prominently, before or instead of domain names with weaker nodes in a domain name suggestion list.

The server computer may generate a preliminary list of tokenization variants (e.g., list one—“micahae,” “lice,” “factory;” list two “michae.” “lice,” “fact,” “ory,” list three—“michael,” “ice,” “factory;” and list four—“michael,” “ice,” “fact,” “ory,” etc.) A simple term frequency may be used in this example to determine that the tokens “michael” and “ice” are more probable than “michae” and “lice”, since “michae” would show up infrequently in the dictionary.

Additional sources may also be used to determine frequency and/or co-occurrence, including search engine request logs, Wikipedia titles, people names (census data), product names (e.g., Kindle), city names, etc. Identified dictionary entries may be stored in the database along with an indication of the terms frequency of use and co-occurrence with other terms.

As queries are received, the server computer determines preferred terms (from the dictionary and/or database) using term frequency, as described above and/or co-occurrence of terms. The server computer may also identify terms/words that are more likely to appear together. The server computer may then analyzes co-occurrence of terms within the user query to determine preferred terms (e.g., “mickey mouse” vs. “mickey rat” and “kindle” vs “kind le”) and boost bi, tri and/or n grams in the language dictionary and/or list of terms.

The server computer may rank the variants and terms according to a score indicating a probability of intended meaning by the user. The score may be based on term frequency and/or co-occurrence of terms as described above.

As more information is compiled, frequency (e.g., how frequently a term is used) and co-occurrence information (e.g., how frequently do terms appear together) may also come from user feedback loops (e.g., how frequently do users select domain names that comprise the terms?). This information may continue to be stored in the dictionary on the database. A plurality of suggested domain names may be created, preferably with terms with a high frequency of use and/or co-occurrence of terms either within a text body or as part of a previously selected and/or registered domain name. (Step 1602)

The user may be presented with a plurality of suggested domain names, possibly based on their query, ranked according to scores of term frequency and/or term co-occurrence (e.g., “kind,” “le,” “books,” “star,” and “wars” vs. “kind,” “le,” “book,” “star,” and “war,” vs “kindle,” “books,” “star,” “wars”). (Step 1603)

The server computer may discover or identify a “new” term (e.g., “kindle” or “ipad”). The server computer may receive feedback on the new term (e.g., user clicks on “kindle” or selects the suggested domain name variant spin with “kindle”).

The server computer may “promote” terms and/or variants within a selected domain name with a higher score or rank in the dictionary stored in the database (e.g., “kindle” is promoted and receives a higher score result in the dictionary stored in the database if “kindle” is part of a selected and/or registered suggested domain name.)

The server computer may “demote” terms and/or variants with a non-selected and/or non-registered domain name with a lower score or rank in the dictionary stored in the database (e.g., “kindle” is demoted and receives a lower score result in the dictionary or database if “kindle” is part of an unselected domain name.)

Search logs, dictionaries and/or databases may be updated to reflect the higher or lower scoring or ranking of terms in selected and unselected suggested domain names. Subsequently the server computer may intelligently determine which combinations and/or new terms are being selected by users and score or rank them higher.

Suggested domain names with higher ranking terms based on the frequency of their use, purchase probabilities or their co-occurrence with other terms may be given priority and shown more prominently, instead of and/or before suggested domain names with lower ranking terms,

In some embodiments, “discovered” terms (possibly with a large flux of new or combined terms) may be included to see if users will select them thereby generating higher scores and making the system more intelligent over time. The server computer can either flag these terms for review or the terms can be automatically added to the dictionary stored on the database.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention. As examples, while the invention has been described in detail for spinning domain names, the invention may also be used to spin name identifiers in other fields. As specific non-limiting examples, the invention may also be used to spin name identifiers for license plates, phone numbers and social media name identifiers.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method, comprising the steps of:
a) storing a dictionary on a one or more server computers, wherein the dictionary includes a first plurality of terms and an indication of how frequently each of the terms in the first plurality of terms is used within a body of text;
b) generating, by the one or more server computers, a second plurality of terms associated with a user;
c) creating, by the one or more server computers, a plurality of suggested domain names by combining one or more terms in the second plurality of terms with a domain name extension; and
d) displaying, by the one or more server computers, one or more of the plurality of suggested domain names to the user, wherein domain names in the plurality of suggested domain names that comprise more frequently used terms are displayed before or instead of domain names in the plurality of suggested domain names that comprise less frequently used terms.

2. The method of claim 1, further comprising the step of:
e) building the dictionary by crawling the body of text and extracting the first plurality of terms.

3. The method of claim 1, wherein the second plurality of terms are generated from a user search entered by the user.

4. The method of claim 1, wherein the second plurality of terms are generated from information that is associated with the user.

5. The method of claim 1, wherein the second plurality of erms are generated by a keyword spinner.

6. The method of claim 1, further comprising the step of:
e) enabling, by the one or more server computers, the user to manipulate the plurality of terms on the website.

7. The method of claim 1, further comprising the steps of:
e) checking an availability of each domain name in the plurality of suggested domain names; and
f) displaying only available domain names in the plurality of suggested domain names on the website to the user.

8. A method, comprising the steps of:
a) storing a dictionary on a one or more server computers, wherein the dictionary includes a first plurality of terms and an indication of how often a first term in the first plurality of terms occurs next to a second term in the first plurality of terms within a body of text;
b) generating, by the one or more server computers, a second plurality of terms associated with a user;
c) creating, by the one or more server computers, a plurality of suggested domain names by combining one or more terms in the second plurality of terms with a domain name extension; and
d) displaying, by the one or more server computers, one or more of the plurality of suggested domain names to the user, wherein domain names in the plurality of suggested domain names that comprise terms that frequently occur together within the body of text are displayed before or instead of domain names in the plurality of suggested domain names that comprise terms that less frequently occur together within the body of text.

9. The method of claim 8, further comprising the step of:
e) building the dictionary by crawling the body of text and extracting the first plurality of terms.

10. The method of claim 8, wherein the second plurality of terms are generated from a user search entered by the user.

11. The method of claim 8, wherein the second plurality of terms are generated from information that is associated with the user.

12. The method of claim 8, wherein the second plurality of terms are generated by a keyword spinner.

13. The method of claim 8, further comprising the step of:
e) enabling, by the one or more server computers, the user to manipulate the second plurality of terms on the website.

14. The method of claim 8, further comprising the steps of:
e) checking an availability of each domain name in the plurality of suggested domain names; and
f) displaying only available domain names in the plurality of suggested domain names on the website to the user.

15. A method, comprising the steps of:
a) storing a dictionary on a one or more server computers, wherein the dictionary comprises a first plurality of words and an indication of a strength of a node between a first word in the first plurality of words and a second word in the first plurality of words;
b) generating, by the one or more server computers, a second plurality of words associated with a user;
c) creating, by the one or more server computers, a plurality of suggested domain names by combining one or more words in the second plurality of words with a domain name extension; and
d) displaying, by the one or more server computers, one or more of the plurality of suggested domain names to the user, wherein domain names in the plurality of suggested domain names that comprise words with a strong node between the words are displayed before or instead of domain names in the plurality of suggested domain names that comprise words with a weak node between the words.

16. The method of claim 15, further comprising the step of:
e) building the dictionary by crawling the body of text and extracting the first plurality of tokens.

17. The method of claim 15, wherein the second plurality of tokens are generated from a user search entered by the user.

18. The method of claim 15, wherein the second plurality of tokens are generated from information that is associated with the user.

19. The method of claim 15, wherein the second plurality of okens are generated by a keyword spinner.

20. The method of claim 15, further comprising the step of:
e) enabling, by the one or more server computers, the user to manipulate the plurality of tokens on the website.

21. The method of claim 15, further comprising the steps of:
e) checking an availability of each domain name in the plurality of suggested domain names; and
f) displaying only available domain names in the plurality of suggested domain names on the website to the user.
